(19) United States
(12) Patent Application Publication
(10) Pub. No.: US 2020/0390139 A1
(43) Pub. Date: Dec. 17, 2020

(54) GENDER SPECIFIC SYNTHETIC NUTRITIONAL COMPOSITIONS AND NUTRITIONAL SYSTEMS COMPRISING THEM

(71) Applicant: SOCIÉTÉ DES PRODUITS NESTLÉ S.A., Vevey (CH)

(72) Inventors: Michael Affolter, Savigny (CH); Sagar Thakkar, Brent (CH); Carlos Antonio De Castro, Geneva (CH)

(21) Appl. No.: 17/006,052

(22) Filed: Aug. 28, 2020

Related U.S. Application Data
(62) Division of application No. 15/302,752, filed on Oct. 7, 2016.

(30) Foreign Application Priority Data
Apr. 9, 2014 (CN) PCT/CN2014/074990

(51) Int. Cl. A23L 33/175; A23L 33/00

(52) U.S. Cl. CPC A23L 33/175; A23L 33/40; A23L 33/19; A23V 2250/063; A23V 2200/00; A23V 2002/00

(57) ABSTRACT

Gender specific synthetic nutritional compositions for infants 1 to 2 months of age or up to 1 month of age wherein, the concentration of lysine is adapted based on that found in HM produced for an infant of the same gender and age, and nutritional systems comprising them.

### TECHNICAL FIELD

The invention relates to gender specific synthetic nutritional compositions, to nutritional systems comprising them and, to their use to provide optimised nutrition and/or one or more health benefit to an infant.

### BACKGROUND OF THE INVENTION

Even though breastfeeding is optimal for infants, the existence of certain conditions may mean that it is contraindicated (AAP, 2012; Lawrence, 2013). In such cases, where the sole source of nutrition is not available to the infant, alternative strategies to feed them have to be devised. Feeding infants with Synthetic nutritional compositions e.g. Infant formula is one such strategy.

The compositions of the aforementioned synthetic nutritional compositions are modeled on those of human milk. However, the composition of HM is extremely dynamic and these dynamic changes remain largely unexplored and uncharacterized. Whilst it is known that components and/or their quantities may vary depending on a variety of factors including the stage of lactation, circadian rhythms and even gender, it is not known which of the numerous components vary and if so how they vary e.g. by stage of lactation and/or gender.

Surprisingly it has now been identified that 1 to 2 months, and up to 1 month, more particularly 2 weeks to 1 month, postpartum, there can be a difference in the lysine concentration range found in HM produced by mothers to girls in comparison to mothers to boys. This finding stems from a cross-sectional study of HM wherein, HM samples from mothers to either boys or girls were collected at various stages postpartum and analysed. Further, it was also surprisingly found that up to 1 month, more particularly 2 weeks to 1 month, postpartum, the mean concentration of lysine in HM produced by mothers to boys was higher than that produced for mothers to girls. Conversely it was surprisingly found that 1 to 2 months postpartum the mean concentration of lysine in HM produced by mothers to boys was lower than that produced for mothers to girls.

Because these gender differences in the concentration of lysine in HM have never been previously identified, they are not reflected in the compositions of synthetic nutritional compositions available today.

Lysine is an amino acid. An optimum intake of amino acids helps to ensure optimum growth and development in infants.

Optimum growth and development may be immediate and/or long term. Long term may only be evident in months or years e.g. 6 months, 9 months, 12 months, 5 years, 10 years, or 20 years.

Accordingly, there remains a need for gender specific synthetic nutritional compositions, and nutritional systems comprising them, having compositions within which the identified gender differences, with respect to concentration of lysine, found in HM 1 to 2 months, and up to 1 month, more particularly 2 weeks to 1 month, postpartum are more accurately reflected and thereby optimised.

### SUMMARY OF THE INVENTION

The invention is set out in the claims. The inventors have found that the concentration range of lysine in HM varies 1 to 2 months and up to 1 month, more particularly 2 weeks to 1 month, postpartum depending on the gender of the mother's infant. In light of this finding the inventors have developed gender specific nutritional compositions, and nutritional systems comprising them, that reflect these identified gender differences. Prior to aforementioned findings the skilled person had no incentive to develop such gender specific synthetic nutritional compositions or to include them in nutritional systems.

The concentration of lysine in the gender specific synthetic nutritional compositions of the invention, and nutritional systems comprising them, more accurately reflect the concentration of lysine found in HM produced for infants of the same gender and age. In light of this and, because HM is considered optimal with respect to infant nutrition, they can provide an optimized amount of total lysine to an infant, in particular an infant of 1 to 2 months of age, and up to 1 month of age, more particularly 2 weeks to 1 month of age.

The gender specific synthetic nutritional compositions can be prepared from a gender neutral synthetic nutritional composition by measuring out an appropriate amount of said gender neutral synthetic nutritional composition and mixing it with an additive and/or diluent.

Since optimised lysine intake is helps ensure the optimum growth and development of an infant, the gender specific synthetic nutritional compositions, and nutritional systems of the invention, can also be used to treat, prevent or mitigate sub optimal growth e.g. obesity of an infant.

Optionally the gender specific synthetic nutritional composition is selected from the group consisting of: infant formula, and a composition for infants that is intended to be added or diluted to human milk e.g. HM fortifier.

In addition to that set out above the inventors have also found that the mean concentration of lysine in HM does not vary by gender after 2 months postpartum. In light of this, in addition to comprising the gender specific synthetic nutritional compositions of the invention, the nutritional systems disclosed herein may optionally also comprise synthetic nutritional compositions for infants more than 2 months of age wherein, the concentration of lysine does not differ by gender for infants of the same age. Accordingly, the nutritional systems of the invention may also provide optimized nutrition and thereby be used to treat, prevent or mitigate sub optimal growth of an infant e.g. obesity of an infant in particular an infant up to 12 months of age, up to 9 months of age, up to 8 months of age, up to 6 months of age, up to 5 months of age, up to 3 months of age, up to 1 months of age.

### DRAWINGS

FIG. 1 is a graphical representation of the mean concentration of lysine in HM by gender at up to 2 weeks (5-11 days), 2 weeks to 1 month (12-30 days), 1 to 2 months (31 to 60 days), 2 to 4 months (61 to 120 days), and 4 to 8 months (121 to 240 days) postpartum.

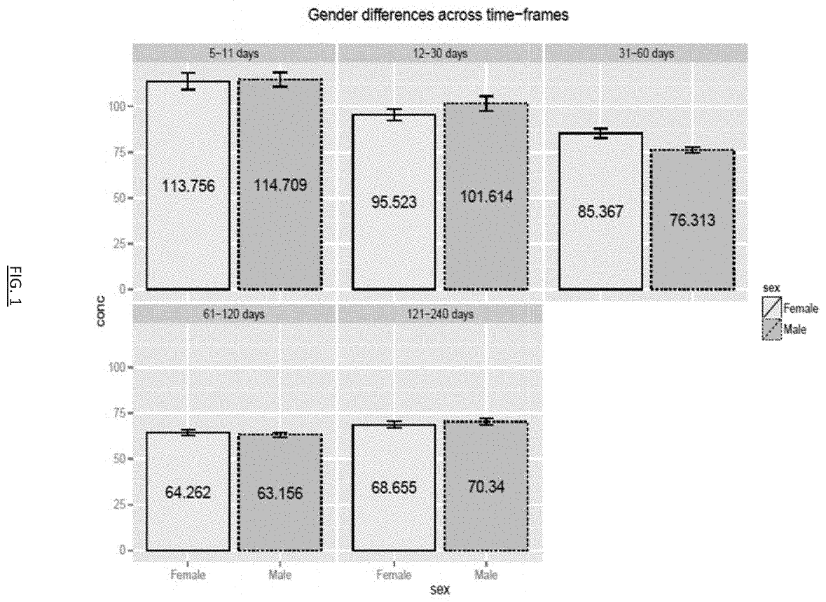

### DETAILED DESCRIPTION

As stated herein, the inventors performed a cross sectional study evaluating the nutrient composition of HM collected from mothers at various stages of lactation (up to 2 weeks (5-11 days), 2 weeks to 1 month (12-30 days), 1 to 2 months (31 to 60 days), 2 to 4 months (61 to 120 days), and 4 to 8 months (121 to 240 days) postpartum). The study indicated that there can be different min and max ranges for the concentration of lysine by gender. Surprisingly, the results of this study also indicated that 1 to 2 months, and up to 1 month, more particularly 2 weeks to 1 month, postpartum, there is a difference in the mean concentration of lysine in HM depending on the gender of the mother's infant. Further details of the study, analysis techniques and results are given in example 1.

Based on the findings of the study, the inventors have designed gender specific synthetic nutritional compositions for infants 1 to 2 months up to 1 month, and 2 weeks to 1 month of age wherein, the concentration of lysine is adapted based on that found in HM produced for an infant of the same gender and age.

The term “gender specific synthetic nutritional composition” as used herein refers to any synthetic nutritional composition, intended to be consumed by an infant that is specifically adapted to the nutritional needs of either a female or male enfant.

Non limiting examples of gender specific synthetic nutritional compositions for infants from birth to 4 months include; infant formulae and a composition for infants that is intended to be added or diluted with HM e.g. HM fortifier. Non limiting examples of gender specific synthetic nutritional compositions for infants from 4 months to 12 months include infant formulae, a composition for infants that is intended to be added or diluted with HM e.g. HM fortifier, or food stuffs intended for consumption by infants either alone or in combination with HM e.g. complementary foods.

The term “infant” as used herein refers to a human infant of 12 months of age or less.

In a first aspect of the invention there is provided a gender specific synthetic nutritional composition for an infant 1 to 2 months of age, or up to 1 month of age, more particularly 2 weeks to 1 month of age wherein, the concentration of lysine is adapted based on that found in HM produced for an infant of the same gender and age.

The gender specific synthetic nutritional composition can be a male specific synthetic nutritional composition or a female specific synthetic nutritional composition.

In an embodiment the gender specific synthetic nutritional composition is a female specific synthetic nutritional composition for an infant of 1 to 2 months of age and comprises lysine in a concentration of 57.5 mg to 129.8 mg, 57.5 mg to 120.63 mg, 67.74 mg to 103 mg, 80.84 mg to 129.8 mg, or 85.37 mg, per 100 g.

The lysine concentration of the gender specific synthetic nutritional compositions of the invention is expressed in mg/100 g. This may refer to the total protein content of a reconstituted gender specific synthetic nutritional composition.

In an embodiment the gender specific synthetic nutritional composition is a male specific synthetic nutritional composition for an infant of 1 to 2 months of age and comprises lysine in a concentration of 55.4 mg to 129.8 mg, 55.4 mg to 80 mg, 55.4 mg to 98.95 mg, 64.99 mg to 87.63 mg, or 76.31 mg, per 100 g.

In an embodiment the gender specific synthetic nutritional composition is a female specific synthetic nutritional composition for an infant of up to 1 month, more particularly 2 weeks to 1 month, of age and comprises lysine in a concentration of 68.2 mg to 150.3 mg, 68.2 mg to 135.38 mg, 68.2 mg to 98 mg, 75.59 mg to 115.45 mg, or 95.52 mg, per 100 g.

In an embodiment the gender specific synthetic nutritional composition is a male specific synthetic nutritional composition for an infant of up to 1 month, more particularly 2 weeks to 1 month, of age and comprises lysine in a concentration of 61.5 mg to 239.4 mg, 61.5 mg to 160.13 mg, 72.35 mg to 130.87, 98 mg to 239.4 mg, or 101.61 mg, per 100 g.

The concentration of lysine can be measured by methods well known in the art. In particular its concentration can be measured by an amino acid analyzer (using post-column derivatisation with ninhydrin) or by a pre-column derivatisation method (i.e. using PITC or OPA/FMOC chemistry as described in Blankenship D. T. et al. (1989) Analytical Biochemistry 178: 227) followed by HPLC separation and quantification.

Any source of lysine known to be employed in the types of synthetic nutritional compositions disclosed herein may be comprised within in the gender specific synthetic nutritional compositions of the invention, in particular pure synthetic lysine obtained through synthesis or fermentation, or liberated from any food-grade protein source such as animal or plant proteins through hydrolysis.

The lysine may be intact, hydrolysed, partially hydrolysed, or any combination thereof.

Non limiting examples of such ingredients include: other amino acids, proteins, carbohydrates, oligosaccharides, lipids, prebiotics or probiotics, essential fatty acids, nucleotides, nucleosides, vitamins, minerals and other micronutrients.

Non limiting examples of other amino acids include, arginine, alanine, histidine, isoleucine, proline, valine, cysteine, glutamine, glutamic acid, glycine, serine, leucine, threonine, tyrosine, methionine, phenylalanine, tryptophane, asparagine, aspartic acid, and combinations thereof.

Non limiting examples of proteins include, caseins, alpha-lactalbumin lactoferrin, serum albumin, whey, soy protein, rice protein, corn protein, oat protein, barley protein, wheat protein, rye protein, pea protein, egg protein, sunflower seed protein, potato protein, fish protein, meat protein, immunoglobins, and combinations thereof.

Non limiting examples of carbohydrates include lactose, saccharose, maltodexirin, starch, and combinations thereof.

Non limiting examples of lipids include: palm olein, high oleic sunflower oil, high oleic safflower oil, canola oil, fish oil, coconut oil, bovine milk fat, and combinations thereof.

Non limiting examples of essential fatty acids include: linoleic acid (LA), α-linolenic acid (ALA) and polyunsaturated fatty acids (PUFAs). The nutritional compositions of the invention may further contain gangliosides monosialoganglioside-3 (GM3) and disialogangliosides 3 (GD3), phospholipids such as sphingomyelin, phospholipids phosphatidylcholine, phosphatidylethanolamine, phosphatidylinositol, phosphatidylserine, and combinations thereof.

None limiting examples of prebiotics include: oligosaccharides optionally containing fructose, galactose, mannose; dietary fibers, in particular soluble fibers, soy fibers; inulin; and combinations thereof. Preferred prebiotics are fructo-oligosaccharides (FOS), galacto-oligosaccharides (GOS), isomalto-oligosaccharides (IMO), xylo-oligosaccharides (XOS), arabino-xylo oligosaccharides (AXOS), mannan-oligosaccharides (MOS), oligosaccharides of soy, glycosylsucrose (GS), lactosucrose (LS), lactulose (LA), palatinose-oligosaccharides (PAO), malto-oligosaccharides, gums and/or hydrolysates thereof, pectins and/or hydrolysates thereof, and combinations of the foregoing.

Further examples of oligosaccharide are described in Wrodnigg, T. M.; Stutz, A. E. (1999) Angew. Chem. Int. Ed. 38:827-828 and in WO 2012/069416 which is incorporated herein by reference.

Non limiting examples of probiotics include: Bifidobacterium, Lactobacillus, Lactococcus, Enterococcus, Streptococcus, Kluyveromyces, Saccharomyces, Candida, in particular selected from the group consisting of Bifidobacterium longum, Bifidobacterium lactis, Bifidobacterium animalis, Bifidobacterium breve, Bifidobacterium infantis, Bifidobacterium adolescentis, Lactobacillus acidophilus, Lactobacillus casei, Lactobacillus paracasei, Lactobacillus salivarius, Lactobacillus lactis, Lactobacillus rhamnosus, Lactobacillus johnsonii, Lactobacillus plantarum, Lactobacillus salivarius, Lactococcus lactis, Enterococcus faecium, Saccharomyces cerevisiae, Saccharomyces boulardii or mixtures thereof, preferably selected from the group consisting of Bifidobacterium longum NCC3001 (ATCC BAA-999), Bifidobacterium longum NCC2705 (CNCM I-2618), Bifidobacterium longum NCC490 (CNCM I-2170), Bifidobacterium lactis NCC2818 (CNCM I-3446), Bifidobacterium breve strain A, Lactobacillus paracasei NCC2461 (CNCM I-2116), Lactobacillus johnsonii NCC533 (CNCM I-1225), Lactobacillus rhamnosus GG (ATCC53103), Lactobacillus rhamnosus NCC4007 (CGMCC 1.3724), Enterococcus SF 68 (NCC2768; NCIMB10415), and combinations thereof.

Non limiting examples of Nucleotides include: cytidine monophosphate (CMP), uridine monophosphate (UMP), adenosine monophosphate (AMP), guanosine monophosphate (GMP), and combinations thereof.

Non limiting examples of vitamins and minerals include: vitamin A, vitamin B1, vitamin B2, vitamin B6 vitamin B12, vitamin E, vitamin K, vitamin C, vitamin D, folic acid, inositol, niacin biotin, pantothenic acid choline calcium, phosphorous, iodine, iron, magnesium, copper zinc, manganese, chloride, potassium, sodium, selenium, chromium, molybdenum, taurine, carnitine, and combinations thereof. Minerals are usually added in salt form.

Other suitable and desirable ingredients of synthetic nutritional compositions, that may be employed in the gender specific nutritional compositions of the invention, are described in guidelines issued by the Codex Alimentarius with respect to the type of synthetic nutritional composition in question e.g. Infant formula, HM fortifier, follow on formula, or food stuffs intended for consumption by infants e.g. complementary foods.

The gender specific compositions of the invention may be prepared by methods well known in the art for preparing that type of synthetic nutritional composition e.g. infant formulae, follow on formulae, a composition for infants that is intended to be added or diluted with HM e.g. HM fortifier, and food stuffs intended for consumption by infants either alone or in combination with HM e.g. complementary foods.

An exemplary method for preparing a gender specific powdered infant formula is as follows. Amino acids (including lysine), and/or protein source (comprising bound lysine), carbohydrate source, and fat source may be blended together in appropriate proportions. Emulsifiers maybe included in the blend. Vitamins and minerals may be added at this point but are usually added later to avoid thermal degradation. Any lipophilic vitamins, emulsifiers and the like may be dissolved into the fat source prior to blending. Water, preferably water which has been subjected to reverse osmosis, may then be mixed in to form a liquid mixture.

The liquid mixture may then be thermally treated to reduce bacterial loads. For example, the liquid mixture may be rapidly heated to a temperature in the range of about 80° C. to about 110° C. for about 5 seconds to about 5 minutes. This may be carried out by steam injection or by heat exchanger; for example a plate heat exchanger.

The liquid mixture may then be cooled to about 60° C. to about 85° C.; for example by flash cooling. The liquid mixture may then be homogenised; for example in two stages at about 7 MPa to about 40 MPa in the first stage and about 2 MPa to about 14 MPa in the second stage. The homogenised mixture may then be further cooled to add any heat sensitive components such as vitamins and minerals. The pH and solids content of the homogenised mixture is conveniently standardised at this point.

The homogenised mixture can be transferred to a suitable drying apparatus such as a spray drier or freeze drier and converted to powder. The powder should have a moisture content of less than about 3% by weight.

If it is desired probiotic(s) can be added, they may be cultured according to any suitable method and prepared for addition to the infant formula by freeze-drying or spray-drying for example. Alternatively, bacterial preparations can be bought from specialist suppliers such as Christian Hansen and Morinaga already prepared in a suitable form for addition to food products such as infant formula. Such bacterial preparations may be added to the gender specific powdered infant formula by dry mixing.

The gender specific compositions of the invention may also be prepared from a gender neutral synthetic nutritional composition in a method comprising; measuring out an appropriate amount of said gender neutral synthetic nutritional composition and mixing it with an additive and/or diluent e.g. water so as to arrive at a gender specific nutritional composition in accordance with the invention.

The additive may be a gender specific additive comprising lysine in a particular concentration so that when mixed with the gender neutral synthetic nutritional composition, and optionally a diluent, the resulting mixture is a gender specific synthetic nutritional composition of the invention.

The gender neutral synthetic nutritional composition can be prepared by methods well known in the art. For example as laid out above for infant formula.

One or more of the gender specific synthetic nutritional compositions of the invention can be included in a nutritional system.

The term “nutritional system” as used herein refers to a collection of more than one synthetic nutritional composition advertised or sold as part of the same product range e.g. a collection of infant formulas sold under the same brand and adapted to the nutritional needs of infants of differing genders and/or ages. The synthetic nutritional compositions making up the nutritional system may be packaged individually e.g. in capsules or boxes. Said packages can be sold individually, grouped together e.g. wrapped by plastic film or combined in a box, or in a combination of these two ways.

The nutritional system may comprise only gender specific synthetic nutritional compositions, or it may comprise a mix of gender specific and gender neutral synthetic nutritional compositions.

The term “gender neutral” as used herein is synonymous with unisex.

In a further aspect of the present invention there is provided a nutritional system comprising at least one of the gender specific synthetic nutritional compositions of the invention.

In an embodiment the nutritional system comprises at least one gender specific synthetic nutritional composition for a male infant and at least one gender specific nutritional composition for a female infant wherein, said male and female gender specific synthetic nutritional compositions are for infants of the same age selected from the group consisting of: 1 to 2 months of age, up to 1 month of age, more particularly 2 weeks to 1 month of age.

The herein referenced study indicated that the concentration of lysine comprised in HM produced for male infants up to 1 month of age, more particularly 2 weeks to 1 month of age, was higher than that produced for female infants of the same age. Conversely, the study indicated that concentration of lysine comprised in HM produced for male infants of 1 to 2 months of age was equal to or less than that produced for female infants of the same age.

In an embodiment the gender specific synthetic nutritional compositions, comprised within the nutritional system, are for infants of up to 1 month of age, more particularly 2 weeks to 1 month of age, and the concentration of lysine in said male gender specific synthetic nutritional composition is higher than that of said female gender specific synthetic nutritional composition.

The concentration of lysine in the male gender synthetic nutritional compositions may be higher by any amount.

In an embodiment the ratio of the concentration of lysine between the female gender specific nutritional composition and male gender specific synthetic nutritional composition for infants of up to 1 month of age, more particularly 2 weeks to 1 month of age, is 1:3.51 to 1:1.005, 1:3.51 to 1:1.06; or 1:1.5 to 1:1.06, and/or the male gender specific nutritional composition comprises 171.2 mg to 6.09 mg, 171.2 mg to 0.001 mg, 89.1 mg to 6.09 mg more lysine per 100 g than the female gender specific nutritional composition.

In another embodiment the gender specific synthetic nutritional compositions, comprised within the nutritional system, are for infants of 1 to 2 months of age and the concentration of lysine in said male gender specific synthetic nutritional composition is lower than that of said female gender specific synthetic nutritional composition.

The concentration of lysine in the male gender synthetic nutritional compositions may be lower by any amount.

In another embodiment the nutritional system comprises male and female gender specific synthetic nutritional compositions for infants 1 to 2 months of age wherein, the ratio of the lysine concentration between the female gender specific nutritional composition and male gender specific synthetic nutritional composition is 1:0.99 to 1:0.89, or 1:0.97 to 1:0.89, and/or the female gender specific nutritional composition comprises 2.1 mg to 0.001 mg, or 2.1 mg to 9.06 mg more lysine per 100 g than the male gender specific nutritional composition.

In addition to that disclosed hereinabove, the referenced study further indicated that up to two weeks postpartum and after 2 months postpartum, there is no difference in the concentration of lysine in HM depending on the gender of the mother's infant.

In another embodiment the nutritional system further comprises gender specific synthetic nutritional compositions for infants of up to 2 weeks of age and/or more than 2 months of age wherein, the concentration of lysine does not differ by gender for infants of the same age.

In another embodiment the nutritional system further comprises gender neutral synthetic nutritional compositions for infants up to 2 weeks of age and/or more than 2 months of age.

Non limiting examples of ages, or ranges thereof, more than 2 months of age, include: 3 months, 2-4 mths, 3-6 mths, 4-6 mths, 4-8 mths 6-12 mths, 7-12 mths.

The nutritional system may further comprise nutritional compositions for children older than 12 months.

A gender specific synthetic nutritional composition and/or nutrition system according to the invention is particularly suitable for use in a method of preparing single servings of infant formula using capsules, each capsule of which contains a unit dose of a synthetic nutritional composition in concentrated form, and which is equipped with opening means contained within the capsule to permit draining of the reconstituted synthetic nutritional composition directly from the capsule into a receiving vessel such as a baby bottle. Such a method is described in WO2006/077259.

The different synthetic nutritional compositions, including gender specific and gender neutral synthetic nutritional compositions, which may be comprised within a nutrition system, may be packed into individual capsules and presented to the consumer in multipacks containing a sufficient number of capsules to meet the requirements of an infant of a particular age or age range for one week for example. Suitable capsule constructions are disclosed in WO2003/059778.

The capsules can contain the synthetic nutritional compositions, (gender specific and gender neutral) in the form of powders or concentrated liquids in both cases for reconstitution by an appropriate amount of water. Both the composition and the quantity of infant formula in the capsules may vary according to the gender and/or age of the infant. If necessary, different sizes of capsules may be provided for the preparation of infant formulas for infants of different genders and/or ages.

The gender specific synthetic nutritional compositions, or nutritional systems comprising them, better reflect the differences in the concentration of lysine found in HM depending on the gender of the mother's infant at one or more stages of lactation. As stated herein, optimum lysine intake helps to ensure the optimum growth and development of an infant.

In another aspect of the present invention there is provided a gender specific synthetic nutritional composition and/or nutritional system as disclosed herein, for use to treat, prevent or mitigate sub optimal growth of an infant e.g. obesity.

In another aspect of the present invention there is provided the use of a gender specific synthetic nutritional composition and/or nutritional system as disclosed herein for use in the manufacture of a medicament for use to treat, prevent or mitigate sub optimal growth and development e.g. obesity, of an infant.

A gender specific synthetic nutritional composition may provide an optimum amount of lysine, to an infant, in particular an infant 1 to 2 months of age, or up to 1 month of age, more particularly 2 weeks to 1 month of age.

The nutritional system may provide an optimum amount of total lysine to an infant, in particular an infant up to 12 months of age, up to 9 months of age, up to 8 months of age, up to 6 months of age, up to 1 month of age.

In another aspect of the present invention there is provided a method for providing an optimum amount of lysine to an infant, in particular an infant of 1 to 2 months of age, or up to 1 month of age, more particularly 2 weeks to 1 month of age comprising:
a) Optionally preparing a gender specific synthetic nutritional composition according to the invention from a gender neutral synthetic nutritional composition;
b) Feeding a gender specific synthetic nutritional composition according to the invention to an infant of 1 to 2 months of age, or up to 1 month of age, more particularly 2 weeks to 1 month of age.

As stated herein. The gender specific synthetic nutritional compositions may be prepared from gender neutral synthetic nutritional compositions. Accordingly, in another aspect of the present invention there is provided a kit for providing an optimized amount of total lysine to an infant, in particular an infant of 1 to 2 months of age, or up to 1 month of age, more particularly 2 weeks to 1 month of age, the kit comprising:
a) A gender neutral synthetic nutritional composition
b) A label indicating dosage requirements for an infant so as to arrive at a gender specific nutritional composition in accordance with the invention.

The dosage requirements may be with respect to the quantity of the gender neutral synthetic nutritional employed and/or consumption frequency e.g. 4 times per day.

Subjects included in the survey referenced herein were recruited from 4 provinces across China. Accordingly, the gender specific synthetic nutritional compositions and/or nutritional systems disclosed herein can be particularly relevant for Chinese infants, and or infants born in populations having common genetic origins and/or ethnic origins and/or common dietary habits thereto e.g. Asian, Indian, and/or Mongoloid populations.

It should be appreciated that all features of the present invention disclosed herein can be freely combined and that variations and modifications may be made without departing from the scope of the invention as defined in the claims. Furthermore, where known equivalents exist to specific features, such equivalents are incorporated as if specifically referred to in this specification.

There now follows a series of non-limiting examples that serve to illustrate the invention.

### EXAMPLES

### Example 1

The concentration of lysine in HM samples collected from mothers to either male or female infants was analysed at various stages postpartum. The HM samples were collected as part of a cross sectional survey of HM. The study criteria is set out below:

### Study Population

Number of Subjects

Total 540 healthy subjects were enrolled, allowing a drop-out rate of 10 percent. They were comprised of:
480 Lactating mothers in 3 cities (Beijing, Suzhou and Guangzhou)
30 mothers per city for each of the 5 time points (5 toll days, 12 to 30 days, 1 to 2 months, 2 to 4 months, and 4 to 8 months)

### Inclusion/Exclusion Criteria

Inclusion: Healthy Chinese lactating mothers without history of acute and chronic diseases; exclusively breast feeding mothers during 4 months after delivery were enrolled.
Exclusion: Chinese lactating mothers having history of psychopathic tendencies and having no dietary memory.

The concentration of lysine in the HM samples collected as part of the above detailed study were analyzed using firstly acid hydrolysis in 6 M hydrochloric acid at 110° C. for 22 hrs with phenol antioxidant in the absence of oxygen to liberate all protein-bound lysine, followed secondly by high-sensitivity amino acid analysis using derivatisation with o-Phthalaldehyde (OPA) and 9-Fluorenylmethyl Chloroformate (FMOC), and fluorescence detection (Blankenship D. T. et al. (1989) Analytical Biochemistry 178: 227).

The results of the compositional analysis of the HM survey, with respect to the concentration of lysine are shown in table I.

TABLE I
Concentration of lysine mg/100 g

| | Female | | | | Male | | | |
|---|---|---|---|---|---|---|---|---|
| Stage | Min | Mean | SD | Max | Min | Mean | SD | Max |
| 5 to 11 | 67 | 113.76 | 32.06 | 213.9 | 47.7 | 114.71 | 27.92 | 213.9 |
| days | | | | | | | | |
| 12 to 30 | 68.2 | 95.52 | 19.93 | 150.3 | 61.5 | 101.61 | 29.26 | 239.4 |
| days | | | | | | | | |
| 1 to 2 | 57.5 | 85.37 | 17.63 | 129.8 | 55.4 | 76.31 | 11.32 | 129.8 |
| months | | | | | | | | |
| 2 to 4 | 46.7 | 64.26 | 10.15 | 88.6 | 38.7 | 63.16 | 9.74 | 88.6 |
| months | | | | | | | | |
| 4 to 8 | 41.1 | 68.65 | 13.48 | 117.5 | 50.4 | 70.34 | 13.03 | 127.6 |
| months | | | | | | | | |

The results of the compositional analysis were then subject to a statistical analysis employing the following statistical model:

Concentration=sex+timeframe+timeframe sex:timeframe−city+ε

ε referring to the residual error and sex:timeframe referring to the interaction between these 2 variables.

The following table shows the estimates for gender differences per timeframe along with the corresponding Pvalues.

The results of the Statistical analysis (statistical inference) are show in in table II.

TABLE II

| | Vari- | | | | |
|---|---|---|---|---|---|
| Timeframe | able | Estimate | lower | Upper | Pvalue |
| 5 to 11 | Lysine | −1.82859 | −9.703524 | 6.04635 | 0.6484244 |
| days | | | | | |
| 12 to 30 | Lysine | −6.58863 | −14.661542 | 1.48428 | 0.1094549 |
| days | | | | | |
| 1 to 2 | Lysine | 8.66436 | 0.823594 | 16.50512 | 0.0303948 |
| months | | | | | |
| 2 to 4 | Lysine | 1.16830 | −6.539060 | 8.87565 | 0.7659604 |
| months | | | | | |
| 4 to 8 | Lysine | −1.88452 | −9.718050 | 5.94902 | 0.6366567 |
| months | | | | | |

A P-value inferior to 0.1 for a particular timeframe suggests that there is a statistically significant difference in the concentration of lysine in HM produced for males and females infants at that specific timeframe.

As can be seen from the results in table II, a statistically significant difference in the concentration of lysine between HM produced for male and female infants was identified at 1 to 2 months postpartum and up to 1 month postpartum, more specifically 12 to 30 days postpartum. No statistically significant difference was identified in the concentration of lysine between HM produced for male and female infants up to 2 weeks (5-11 days) postpartum or older than 2 months postpartum Viz. 2 to 4 months and 4 to 8 months.

### Example 2

Examples of gender specific infant formulas are given in table III

TABLE III

| | Up to one month of age | | 1 to 2 months of age | |
|---|---|---|---|---|
| | F | M | F | M |
| Ingredients | Per Litre | | Per Litre | |
| Energy (kcal) | 670 | 670 | 670 | 670 |
| Protein (g) | 10.01 | 10.8 | 10.01 | 10.8 |
| lysine (Free or | 0.096 | 0.102 | 0.085 | 0.076 |
| protein bound) | | | | |
| (g) | | | | |
| Fat (g) | 35.7 | 35.7 | 35.7 | 35.7 |
| Linoleic acid | 5.3 | 5.3 | 5.3 | 5.3 |
| (g) | | | | |
| α-Linolenic acid | 675 | 675 | 675 | 675 |
| (mg) | | | | |
| Lactose (g) | 74.7 | 74.7 | 74.7 | 74.7 |
| Prebiotic (100% | 4.3 | 4.3 | 4.3 | 4.3 |
| GOS) (g) | | | | |
| Minerals (g) | 2.5 | 2.5 | 2.5 | 2.5 |
| Na (mg) | 150 | 150 | 150 | 150 |
| K (mg) | 590 | 590 | 590 | 590 |
| Cl (mg) | 430 | 430 | 430 | 430 |
| Ca (mg) | 410 | 410 | 410 | 410 |
| P (mg) | 210 | 210 | 210 | 210 |
| Mg (mg) | 50 | 50 | 50 | 50 |
| Mn (μg) | 50 | 50 | 50 | 50 |
| Se (μg) | 13 | 13 | 13 | 13 |
| Vitamin A (μg | 700 | 700 | 700 | 700 |
| RE) | | | | |
| Vitamin D (μg) | 10 | 10 | 10 | 10 |
| Vitamin E (mg | 5.4 | 5.4 | 5.4 | 5.4 |
| TE) | | | | |
| Vitamin K1 | 54 | 54 | 54 | 54 |
| (μg) | | | | |
| Vitamin C (mg) | 67 | 67 | 67 | 67 |
| Vitamin B1 | 0.47 | 0.47 | 0.47 | 0.47 |
| (mg) | | | | |
| Vitamin B2 | 1 | 1 | 1 | 1 |
| (mg) | | | | |
| Niacin (mg) | 6.7 | 6.7 | 6.7 | 6.7 |
| Vitamin B6 | 0.5 | 0.5 | 0.5 | 0.5 |
| (mg) | | | | |
| Folic acid (μg) | 60 | 60 | 60 | 60 |
| Pantothenic acid | 3 | 3 | 3 | 3 |
| (mg) | | | | |
| Vitamin B12 | 2 | 2 | 2 | 2 |
| (μg) | | | | |
| Biotin (μg) | 15 | 15 | 15 | 15 |
| Choline (mg) | 67 | 67 | 67 | 67 |
| Fe (mg) | 8 | 8 | 8 | 8 |
| I (μg) | 100 | 100 | 100 | 100 |
| Cu (mg) | 0.4 | 0.4 | 0.4 | 0.4 |
| Zn (mg) | 5 | 5 | 5 | 5 |

### Example 3

An example of a nutritional system in accordance with the invention is given in table IV.

TABLE IV

| | | | | | 2 to 4 months of |
|---|---|---|---|---|---|
| | Up to one month of age | | 1 to 2 months of age | | ages of age |
| | F | M | F | M | Gender neutral |
| Ingredients | Per Litre | | Per Litre | | Per Litre |
| Energy (kcal) | 670 | 670 | 670 | 670 | 630 |
| Protein (g) | 10.01 | 10.8 | 10.01 | 10.8 | 11.3 |
| lysine (Free or | 0.096 | 0.102 | 0.085 | 0.076 | 0.064 |
| protein bound) | | | | | |
| (g) | | | | | |
| Fat (g) | 35.7 | 35.7 | 35.7 | 35.7 | 31.5 |
| Linoleic acid | 5.3 | 5.3 | 5.3 | 5.3 | 4.7 |
| (g) | | | | | |
| α-Linolenic acid | 675 | 675 | 675 | 675 | 600 |
| (mg) | | | | | |
| Lactose (g) | 74.7 | 74.7 | 74.7 | 74.7 | 75 |
| Prebiotic (100% | 4.3 | 4.3 | 4.3 | 4.3 | 4.0 |
| GOS) (g) | | | | | |
| Minerals (g) | 2.5 | 2.5 | 2.5 | 2.5 | 2.3 |
| Na (mg) | 150 | 150 | 150 | 150 | 158 |
| K (mg) | 590 | 590 | 590 | 590 | 504 |
| Cl (mg) | 430 | 430 | 430 | 430 | 410 |
| Ca (mg) | 410 | 410 | 410 | 410 | 378 |
| P (mg) | 210 | 210 | 210 | 210 | 208 |
| Mg (mg) | 50 | 50 | 50 | 50 | 44 |
| Mn (μg) | 50 | 50 | 50 | 50 | 32 |
| Se (μg) | 13 | 13 | 13 | 13 | 19 |
| Vitamin A (μg | 700 | 700 | 700 | 700 | 570 |
| RE) | | | | | |
| Vitamin D (μg) | 10 | 10 | 10 | 10 | 9.5 |
| Vitamin E (mg | 5.4 | 5.4 | 5.4 | 5.4 | 5.0 |
| TE) | | | | | |
| Vitamin K1 | 54 | 54 | 54 | 54 | 50 |
| (μg) | | | | | |
| Vitamin C (mg) | 67 | 67 | 67 | 67 | 95 |
| Vitamin B1 | 0.47 | 0.47 | 0.47 | 0.47 | 0.6 |
| (mg) | | | | | |
| Vitamin B2 | 1 | 1 | 1 | 1 | 0.6 |
| (mg) | | | | | |
| Niacin (mg) | 6.7 | 6.7 | 6.7 | 6.7 | 3.2 |
| Vitamin B6 | 0.5 | 0.5 | 0.5 | 0.5 | 0.4 |
| (mg) | | | | | |
| Folic acid (μg) | 60 | 60 | 60 | 60 | 95 |
| Pantothenic acid | 3 | 3 | 3 | 3 | 5.0 |
| (mg) | | | | | |
| Vitamin B12 | 2 | 2 | 2 | 2 | 1.3 |
| (μg) | | | | | |
| Biotin (μg) | 15 | 15 | 15 | 15 | 12.6 |
| Choline (mg) | 67 | 67 | 67 | 67 | 95 |
| Fe (mg) | 8 | 8 | 8 | 8 | 6.3 |
| I (μg) | 100 | 100 | 100 | 100 | 95 |
| Cu (mg) | 0.4 | 0.4 | 0.4 | 0.4 | 0.4 |
| Zn (mg) | 5 | 5 | 5 | 5 | 5.7 |

1-16. (canceled)

17. A method to treat, protect or mitigate sub-optimal growth and development of infants, the method comprising:
(a) providing a nutritional system for infants, the nutritional system is selected from the group consisting of:
(i) the nutritional system comprises a female gender specific synthetic nutritional composition for a female infant of 1 month to 2 months of age and further comprises a male gender specific synthetic nutritional composition for a male infant of 1 month to 2 months of age,
a lysine concentration of the male gender specific synthetic nutritional composition is 55.4 mg to 129.8 mg per 100 g,
a lysine concentration of the female gender specific synthetic nutritional composition is 57.5 mg to 129.8 mg per 100 g, and
a ratio of the lysine concentration of the female gender specific nutritional composition to the lysine concentration of the male gender specific synthetic nutritional composition is 1:0.99 to 1:0.89; and
(ii) the nutritional system comprises a female gender specific synthetic nutritional composition for a female infant up to 1 month of age and further comprises a male gender specific synthetic nutritional composition for a male infant up to 1 month of age,
a lysine concentration of the male gender specific synthetic nutritional composition is 61.5 mg to 239.4 mg per 100 g,
a lysine concentration of the female gender specific synthetic nutritional composition is 68.2 mg to 150.3 mg per 100 g, and
a ratio of the lysine concentration of the female gender specific nutritional composition to the lysine concentration of the male gender specific synthetic nutritional composition is 1:3.51 to 1:1.005;
(b) administering the female gender specific synthetic nutritional composition to the female infant; and
(c) administering the male gender specific synthetic nutritional composition to the male infant.

18. The method of claim 17, wherein:
(i) the ratio of the lysine concentration of the female gender specific nutritional composition formulated for the female infant of 1 month to 2 months of age to the lysine concentration of the male gender specific synthetic nutritional composition formulated for the male infant of 1 month to 2 months of age is 1:0.97 to 1:0.89; or
(ii) the ratio of the lysine concentration of the female gender specific nutritional composition formulated for the female up to 1 month of age to the lysine concentration of the male gender specific synthetic nutritional composition formulated for the male infant up to 1 month of age is 1:1.5 to 1:1.06.

19. The method of claim 17, wherein:
(i) the lysine concentration of the male gender specific synthetic nutritional composition for the male infant of 1 month to 2 months of age is 55.4 mg to 98.95 mg/100 g, and
the lysine concentration of the female gender specific synthetic nutritional composition for the female infant of 1 month to 2 months of age is 57.5 mg to 120.63 mg/100 g; or
(ii) the lysine concentration of the male gender specific synthetic nutritional composition for the male infant up to 1 month of age is 61.5 mg to 160.13 mg/100 g, and
the lysine concentration of the female gender specific synthetic nutritional composition for the female infant up to 1 month of age is 68.2 mg to 135.38 mg/100 g.

20. The method of claim 17, wherein:
(i) the lysine concentration of the male gender specific synthetic nutritional composition for the male infant of 1 month to 2 months of age is 55.4 mg to 80 mg/100 g, and
the lysine concentration of the female gender specific synthetic nutritional composition for the female infant of 1 month to 2 months of age is 67.74 mg to 103 mg/100 g; or
(ii) the lysine concentration of the male gender specific synthetic nutritional composition for the male infant up to 1 month of age is 72.35 mg to 130.87 mg/100 g, and
